(19) United States
(12) Patent Application Publication
(10) Pub. No.: US 2007/0138987 A1
(43) Pub. Date: Jun. 21, 2007

(54) Apparatus and method for driving motor

(76) Inventors: Hideki Nishino, Osaka (JP); Kiyotaka Tanimoto, Kyoto (JP); Taishi Iwanaga, Kyoto (JP)

Correspondence Address: MCDERMOTT WILL & EMERY LLP, 600 13TH STREET, N.W., WASHINGTON, DC, 20005-3096, US

(21) Appl. No.: 11/637,741

(22) Filed: Dec. 13, 2006

(30) Foreign Application Priority Data
Dec. 16, 2005 (JP) 2005-362567
Sep. 6, 2006 (JP) 2006-241589

(51) Int. Cl. H02P 7/06

(52) U.S. Cl. 318/254

(57) ABSTRACT

An oscillation frequency selecting section selects any of a first oscillation section and a second oscillation section, depending on whether a signal of a current-passage direction switching section is a forward rotation signal or a brake signal. When the second oscillation section has an oscillation frequency lower than that of the first oscillation section, noise and vibration can be reduced by, for example, selecting the first oscillation section during forward rotation, and the second oscillation section during braking.

### BACKGROUND OF THE INVENTION

1. Field of the Invention

The present invention relates to driving of a multiphase DC brushless motor, and more particularly, to an apparatus and a method for driving a motor, in which noise and vibration during braking are reduced.

2. Description of the Related Art

In magnetic, optical and magneto-optic recording apparatuses and the like, multiphase DC brushless motors, which have high reliability and high speed, are widely used. In general, the multiphase DC brushless motor (hereinafter simply referred to as a motor) is rotated by successively switching currents flowing through phase motor coils based on rotor position information obtained from a back electromotive voltage generated due to the rotation of a position detecting element or a motor.

As a brake, a reverse brake which applies a torque in a reverse rotation direction based on the rotor position information, a short brake which short-circuits all terminals of a motor with a power supply terminal, or the like is widely used.

Also, in recent recording apparatuses, the recording density is being improved, and video/audio recording applications are becoming widespread, and therefore, it is important to reduce noise and vibration during braking as well as during activation or constant rotation of a motor.

Hereinafter, causes for noise and vibration during reverse braking will be described.

FIG. 7 is a block diagram schematically illustrating a conventional motor driving apparatus. FIG. 8 is a chart diagram illustrating a signal waveform of each part of the conventional motor driving apparatus when it is rotated in a forward direction. FIG. 9 is a chart diagram illustrating a signal waveform of each part of the conventional motor driving apparatus when it performs a braking operation. As illustrated in FIG. 7, the conventional motor driving apparatus comprises a brushless motor 200, a rotor position sensor 101, a rotor position detecting section 102, a current-passage control section 103, a motor driving section 104, a motor current detecting section 105, a motor current comparing section 107, a current-passage direction switching section 110, a PWM generating section 109, and an oscillation section 108.

The rotor position sensor 101 detects a rotor position of the brushless motor 200, and outputs a detection signal depending on the rotor position to the rotor position detecting section 102. The rotor position detecting section 102 computes the rotor position detection signal, and outputs a signal for determining a phase of passage of a current through the brushless motor 200 to the current-passage control section 103. When receiving the signal, the current-passage control section 103 outputs a signal to the motor driving section 104, which in turn supplies a current to the brushless motor 200. A current flowing through the brushless motor 200 is detected by the motor current detecting section 105, and the result of the detection is input to the motor current comparing section 107.

The motor current comparing section 107 compares an output signal of the motor current detecting section 105 with a torque command value 106, and outputs the result to the PWM generating section 109. The PWM generating section 109 receives an output signal of the oscillation section 108 and generates a PWM signal for starting the passage of a current through the brushless motor 200, and receives an output signal of the motor current comparing section 107 and generates a PWM signal for interrupting the passage of a current. In this case, the output signal of the oscillation section 108 is a predetermined frequency signal having a pulse width at a predetermined L level as illustrated in FIG. 8.

The predetermined pulse width is set so as to prevent the motor current detecting section 105 from falsely detecting a current due to noise, when the passage of a current through the brushless motor 200 is started in accordance with the output signal of the oscillation section 108. During the pulse width interval, the output signal of the motor current detecting section 105 is ignored. Typically, when the motor driving section 104 starts the passage of a current, the current passage is changed from OFF to ON. In this case, a malfunction occurs in the motor current detecting section 105 due to switching noise. Specifically, a resistance for detecting a current is employed in the motor current detecting section 105. When the passage of a current is switched ON, the voltage of the resistance fluctuates due to an influence of switching noise. Therefore, the motor current detecting section 105 malfunctions.

Specifically, as illustrated in FIG. 8, a current value detected by the motor current detecting section 105 exceeds the torque command value at the moment when a current starts flowing for the first time, so that the output signal of the motor current comparing section 107 goes to the L level for a moment. An interval in which the output signal of the motor current comparing section 107 is at the L level is an interval in which a malfunction occurs. Thus, since the output signal of the oscillation section 108 has a predetermined pulse width, it is possible to prevent the occurrence of a malfunction during the start of driving of the brushless motor 200. The generated PWM signal is input to the current-passage control section 103 to be combined with the output signal of the rotor position detecting section 102, and the result is input to the motor driving section 104, so that the brushless motor 200 is rotated.

The current-passage direction switching section 110 compares the torque command value 106 with a reference voltage 111, and based on the comparison result, outputs a forward rotation signal or a reverse rotation signal to the current-passage control section 103. The current-passage control section 103, when receiving the forward rotation signal, outputs a signal for causing the brushless motor 200 to perform forward rotation (forward rotation signal), and when receiving the reverse rotation signal, outputs a signal whose phase is reversed by 180 degrees compared to during the forward rotation (brake signal).

During the forward rotation of the brushless motor 200, the passage of a current through a motor coil is performed in a direction which makes it difficult for a motor coil current to flow with respect to a back electromotive voltage generated by the rotation of the brushless motor 200. Therefore, it takes a time until a predetermined current is reached, so that the current passage is interrupted, and during this time, the signal of the oscillation section 108 for resuming the current passage is ignored. Therefore, the PWM frequency is apparently lower than the oscillation frequency of the oscillation section 108. Therefore, if the PWM frequency is excessively lowered during forward rotation, a current ripple of the motor coil current becomes significant, leading to noise and vibration.

On the other hand, during reverse braking, the current passage direction is deviated by 180 degrees, and therefore, the passage of a current through the motor coil is performed in a direction which makes it easy for the motor coil current to flow with respect to the back electromotive voltage.

Therefore, as illustrated in FIG. 9, during reverse braking, it takes substantially no time for the motor coil current to reach a predetermined current (torque command value) to interrupt the current passage. Therefore, the PWM frequency is substantially the same as the oscillation frequency of the oscillation section 108, so that the motor coil current becomes considerably large compared to during forward rotation. Note that, during the braking of FIG. 9 as well as during the forward rotation of FIG. 8, when the passage of a current is started in accordance with the output signal of the oscillation section 108, the output signal of the motor current comparing section 107 is ignored during the pulse width interval so as to prevent a signal from being falsely output from the motor current comparing section 107 due to false detection of the motor current detecting section 105 caused by noise.

As described above, noise and vibration become significant particularly during reverse braking, since the noise and vibration increase in proportion to the amount of the motor coil current.

To solve the problem, for example, the occurrence of noise and vibration is suppressed by providing a drive stop control means for stopping the passage of a current through a motor until a predetermined condition is satisfied, when a signal for switching to low-speed rotation is input from an external means (see JP No. 11-136993 A).

Alternatively, the occurrence of noise and vibration is suppressed by providing a means for comparing a rotation frequency signal which is proportional to a rotational speed of a rotor with a reference frequency when a forward/reverse command signal becomes a reverse command, i.e., a brake command is input, and bringing the rotor into a short brake state when the rotation frequency signal is higher than the reference frequency, and into a reverse brake state when the rotation frequency signal is lower than the reference signal (see JP No. 2001-309686 A).

### SUMMARY OF THE INVENTION

However, in the method of JP No. 11-136993 A, whereas noise and vibration can be reduced, the passage of a current is stopped for a predetermined period of time, so that a brake torque does not act, and therefore, access speed is slowed during recording or reading. This is fatal to magnetic, optical, and magneto-optic recording apparatuses and the like.

In the case of the method of JP No.2001-309686 A, if the reference frequency is set to be excessively high, noise and vibration occur when short brake is swiched to reverse brake, and if the reference frequency is set to be excessively low, a brake time is slow.

The present invention solves the above-described drawbacks of the conventional art. An object of the present invention is to provide a motor driving apparatus and a motor dirving method in which noise and vibration are reduced during reverse braking of a multiphase DC brushless motor.

To achieve the object, a first motor driving apparatus according to the present invention comprises a brushless motor, a rotor position detecting section for detecting a rotor position of the brushless motor, a motor current detecting section for detecting a value of a current flowing through the brushless motor, a motor current comparing section for comparing a torque command value with the current value detected by the motor current detecting section, a current-passage direction switching section for comparing the torque command value with a reference voltage, and depending on a result of the comparison, outputting a forward rotation signal or a brake signal having a phase reverse to that of the forward rotation signal, an oscillation section for outputting a first signal and a second signal having a frequency different from that of the first signal, an oscillation frequency selecting section for selecting the first signal or the second signal, depending on the forward rotation signal or the brake signal of the current-passage direction switching section, a PWM generating section for receiving the first signal or the second signal selected by the oscillation frequency selecting section, and a signal of the motor current comparing section, and generating a PWM drive signal, a current-passage control section for combining a signal of the rotor position detecting section and the PWM drive signal, and a motor driving section for PWM-driving the brushless motor, depending on a signal of the current-passage control section.

With this configuration, since signals having frequencies different from each other are output from the oscillation section, vibration and noise can be reduced during dirving of the motor by swiching the signal frequencies. For example, when the second signal has a lower frequency than that of the first signal, the first signal is output during forward rotation of the brushless motor, and the second signal is output during braking. Thereby, the average value of a current flowing through brushless motor during braking can be reduced, thereby making it possible to effectively reduce vibration and noise.

The oscillation section which outputs the first signal and the second signal may comprise a single oscillation section which can changes the oscillation frequency, or alternatively, may have two oscillation sections which output the first signal and the second signal separately.

A second motor driving apparatus according to the present invention comprises a brushless motor, a rotor position detecting section for detecting a rotor position of the brushless motor, a motor current detecting section for detecting a value of a current flowing through the brushless motor, a motor current comparing section for comparing a torque command value with the current value detected by the motor current detecting section, a current-passage direction switching section for comparing the torque command value with a reference voltage, and depending on a result of the comparison, outputting a forward rotation signal or a brake signal having a phase reverse to that of the forward rotation signal, (N+1) oscillation sections (N≧1) for outputting signals having different frequencies, a number-of-revolutions detecting section for detecting the number of revolutions of the brushless motor based on a signal of the rotor position detecting section, a number-of-revolutions comparing section for comparing the number of revolutions detected by the number-of-revolutions detecting section with N predetermined divided ranges of the number of revolutions, and outputting signals having N levels, an oscillation frequency selecting section for receiving the forward rotation signal or the brake signal of the current-passage direction switching section and a signal of the number-of-revolutions comparing section, and selecting any one of the (N+1) oscillation sections, a PWM generating section for receiving an output signal of an oscillation section selected by the oscillation frequency selecting section, and generating a PWM drive signal, a current-passage control section for combining a signal of the rotor position detecting section and the PWM drive signal, and a motor driving section for PWM-driving the brushless motor, depending on a signal of the current-passage control section.

With this configuration, the signal frequency can be finely changed, depending on the number of revolutions of the brushless motor during braking, thereby making it possible to further reduce noise and vibration.

### BRIEF DESCRIPTION OF THE DRAWINGS

FIG. 1 is a block diagram schematically illustrating a configuration of a motor driving apparatus according to a first embodiment of the present invention.

FIG. 2 is a chart diagram illustrating a signal waveform of each part of the motor driving apparatus of the first embodiment during braking.

FIG. 3 is a block circuit diagram illustrating a configuration of a first oscillation section 80 in a variation of the motor driving apparatus of the first embodiment.

FIG. 4 is a block diagram schematically illustrating a configuration of a motor driving apparatus according to a second embodiment of the present invention.

FIG. 5 is a block circuit diagram illustrating specific exemplary configurations of a number-of-revolutions comparing section 31 and an oscillation frequency selecting section 90.

FIG. 6 is a block diagram schematically illustrating a motor driving apparatus according to a third embodiment of the present invention.

FIG. 7 is a block diagram schematically illustrating a conventional motor driving apparatus.

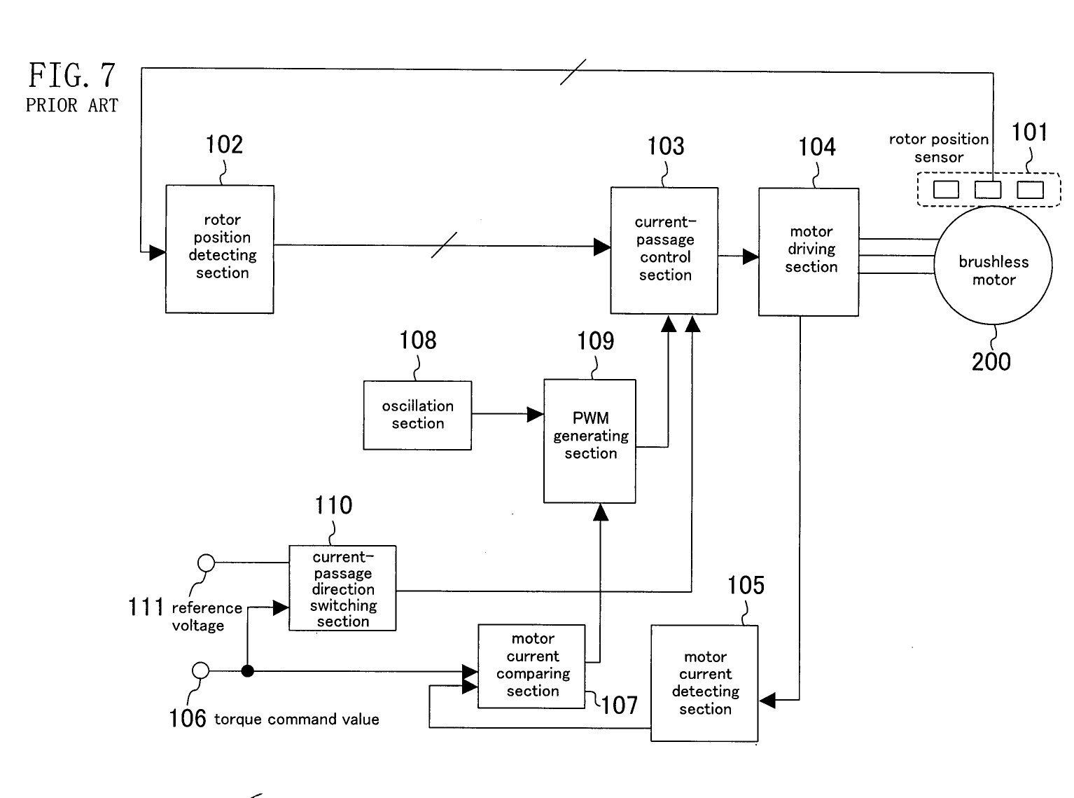

FIG. 8 is a chart diagram illustrating a signal waveform of each part of the conventional motor driving apparatus when it is rotated in a forward direction.

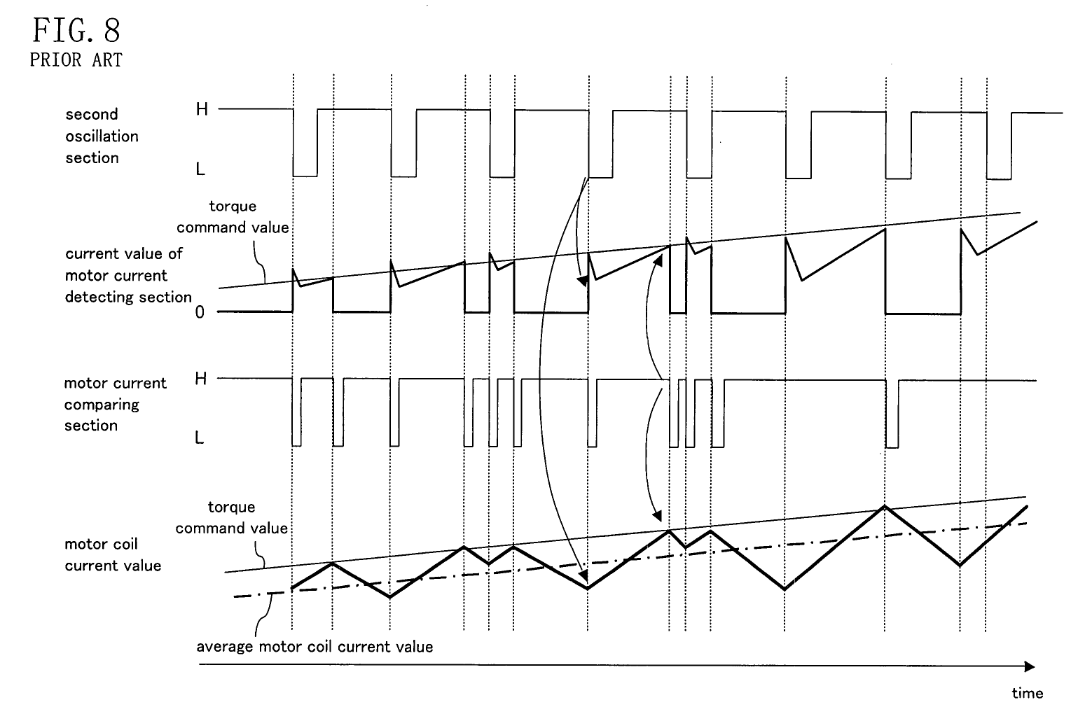

FIG. 9 is a chart diagram illustrating a signal waveform of each part of the conventional motor driving apparatus when it performs a braking operation.

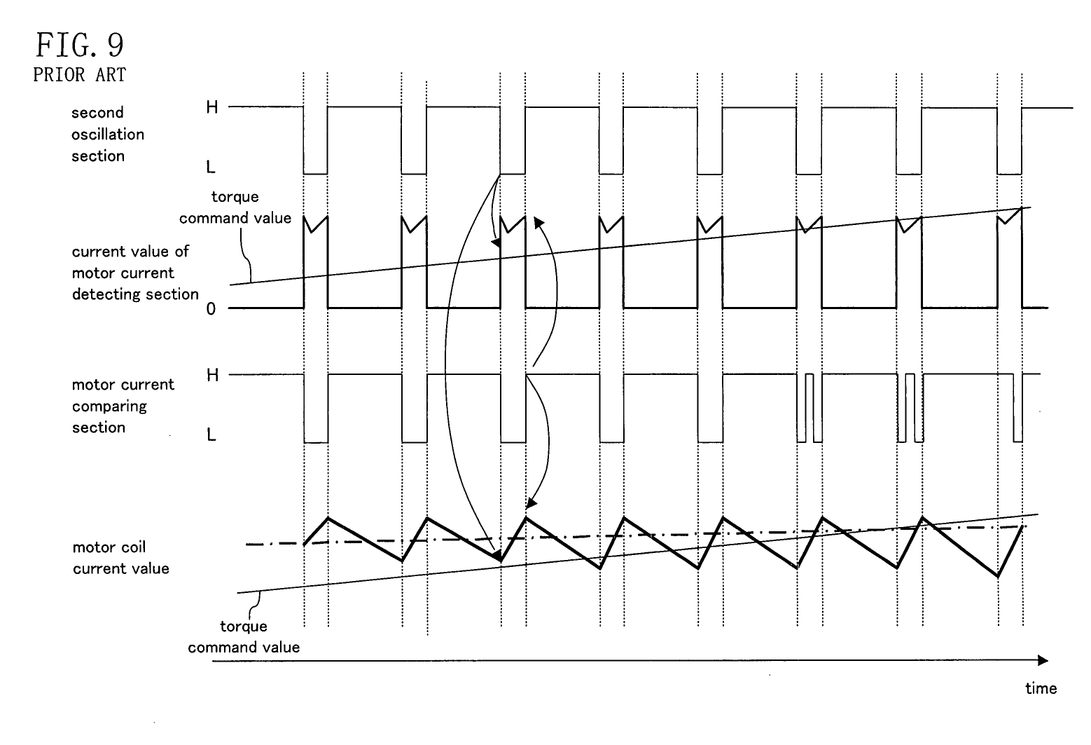

### DETAILED DESCRIPTION OF THE PREFFERED EMBODYMENTS

Hereinafter, embodiments of the present invention will be described in detail with reference to the accompanying drawings.

### First Embodiment

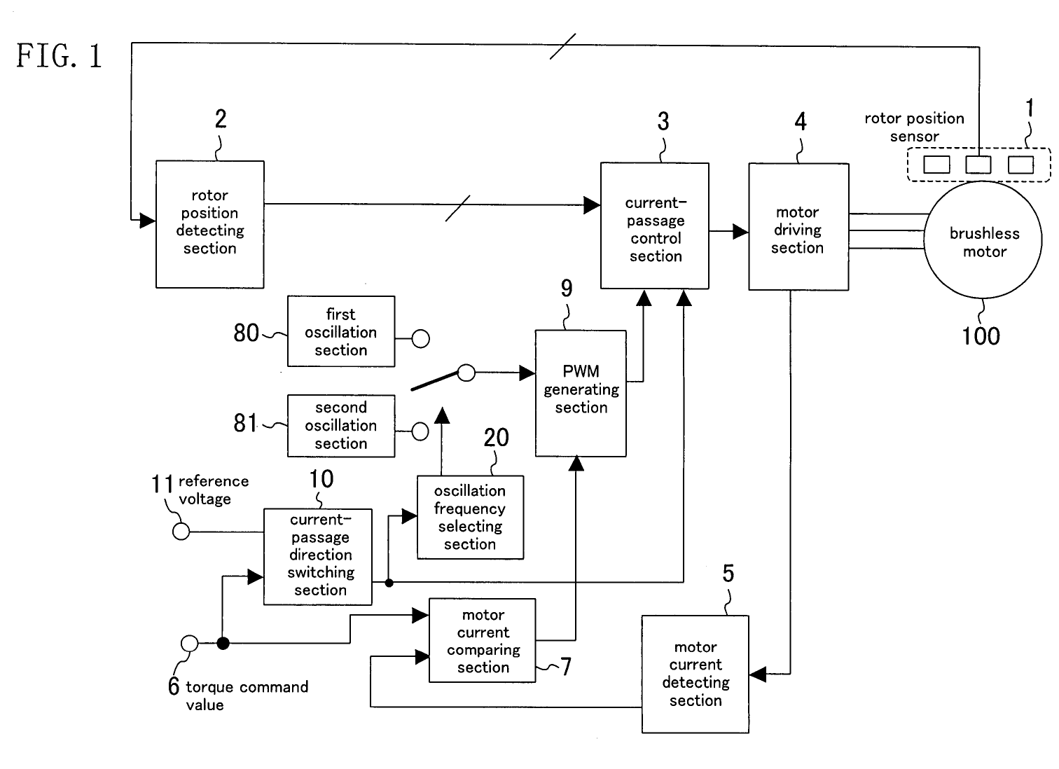

FIG. 1 is a block diagram schematically illustrating a configuration of a motor driving apparatus according to a first embodiment of the present invention. Note that like parts are designated by like reference numerals throughout the drawing for describing the embodiments of the present invention.

As illustrated in FIG. 1, the motor driving apparatus of this embodiment comprises a brushless motor 100, a rotor position sensor 1, a rotor position detecting section 2, a current-passage control section 3, a motor driving section 4, a motor current detecting section 5, a motor current comparing section 7, a current-passage direction switching section 10, an oscillation frequency selecting section 20, a PWM generating section 9, a first oscillation section 80, and a second oscillation section 81.

The motor driving apparatus of this embodiment is characterized in that the first oscillation section 80 and the second oscillation section 81 which output signals having frequencies different from each other are provided, and the oscillation frequency selecting section 20 which selects any of the two signals is provided. In an example of this embodiment, the output signal of the first oscillation section 80 has a higher frequency than that of the output signal of the second oscillation section 81. Operations and function of the parts including these characteristic parts will be hereinafter described.

In the motor driving apparatus of this embodiment, the rotor position sensor 1 detects a rotor position of the brushless motor 100, and outputs a detection signal depending on the rotor position to the rotor position detecting section 2. The rotor position detecting section 2 computes the rotor position detection signal to output a signal for determining a phase of passage of a current through the brushless motor 100 to the current-passage control section 3. When receiving the signal, the current-passage control section 3 outputs a signal to the motor driving section 4, which in turn supplies a current to the brushless motor 100. A current flowing through the brushless motor 100 is detected by the motor current detecting section 5, and the detection result is input to the motor current comparing section 7.

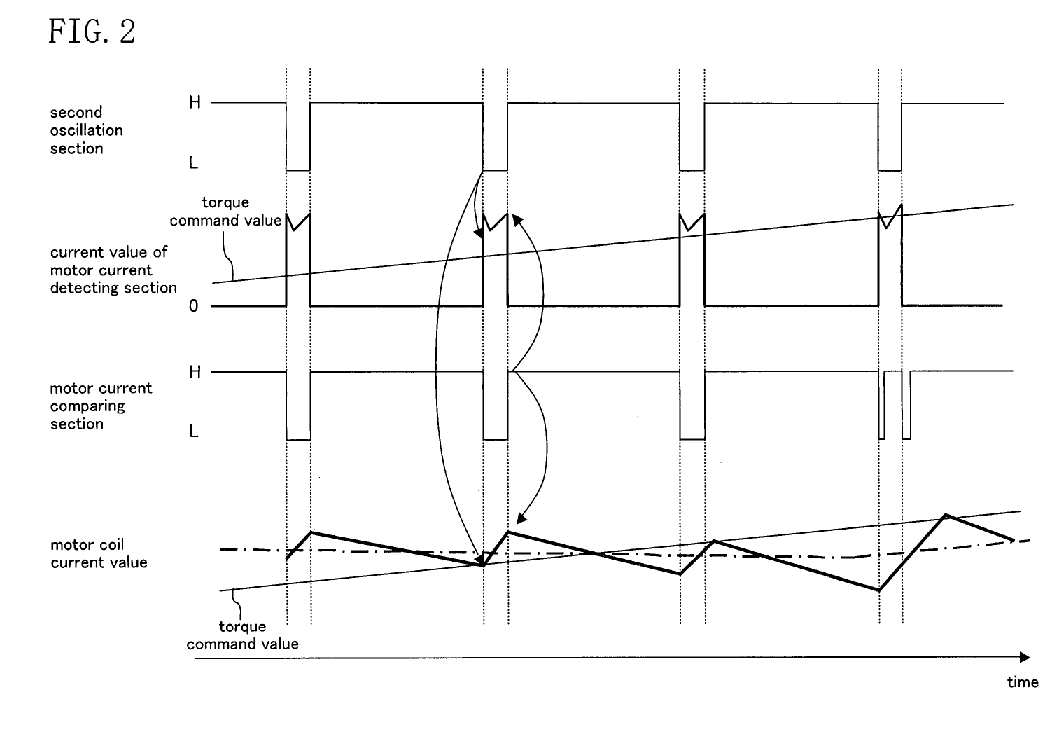

The motor current comparing section 7 comprises a comparator which compares the output signal of the motor current detecting section 5 with a torque command value 6, and outputs the comparison result to the PWM generating section 9. The PWM generating section 9 receives the output signal of the first oscillation section 80 or the second oscillation section 81 and generates a PWM signal for starting passage of a current through the brushless motor 100, and receives the output signal of the motor current comparing section 7 and generates a PWM signal for interrupting the current passage. The PWM generating section 9 comprises, for example, an R/S flip-flop which receives the output signal of the first oscillation section 80 or the second oscillation section 81 at a set terminal thereof, and the output signal of the motor current comparing section 7 at a reset terminal thereof. Note that the output signal of the second oscillation section 81 is a predetermined frequency signal having a pulse width at a predetermined L level as illustrated in FIG. 2. The output signal of the first oscillation section 80 also has a pulse width at a predetermined L level. The predetermined pulse width is set so as to prevent the motor current detecting section 5 from falsely detecting a current due to noise, when the passage of a current through the brushless motor 100 is started in accordance with the output signal of the first oscillation section 80 or the second oscillation section 81.

The current-passage direction switching section 10 compares the torque command value 6 with a reference voltage 11, and depending on the comparison result, outputs a forward rotation signal or a reverse rotation signal to the current-passage control section 3. The current-passage control section 3, when receiving the forward rotation signal, outputs a signal which causes the brushless motor 100 to perform forward rotation, and when receiving the reverse rotation signal, outputs a signal whose phase is inverted by 180 degrees compared to during forward rotation (brake signal).

When the forward rotation signal is output from the current-passage direction switching section 10, the oscillation frequency selecting section 20 selects the first oscillation section 80. The first oscillation section 80 may be a voltage control type oscillation section which outputs a variable oscillation frequency proportional to the torque command value 6, or may be an oscillation section which outputs a fixed frequency. Here, the reason why the first oscillation section 80 which outputs a high frequency signal is selected during the forward rotation of the brushless motor 100, is that the ripple of the motor coil current is prevented from becoming large.

On the oher hand, when the brake signal is output from the current-passage direction switching section 10, the oscillation frequency selecting section 20 selects the second oscillation section 81 which outputs a signal having a lower frequency than that of the output signal of the first oscillation section 80. During braking, the phase of the back electromotive voltage of the brushless motor 100 and the current-passage control signal for the motor coil are inverted by 180 degrees compared to during forward rotation. Therefore, the back electromotive voltage of the brushless motor 100 acts in a direction which makes it easy for a current to flow, so that a current is more easily caused to flow than during forward rotation. Therefore, the current value immediately reaches a command current of the torque command value 6, however, the output signal from the second oscillation section 81 has a predetermined pulse width so as to prevent false detection of the motor current detecting section 5 as illustrated in FIG. 2, and the signal of the motor current detecting section 5 is ignored during the interval (interval in which the signal is at the L level).

The motor coil current during braking does not immediately go to “0” due to an inductance component of the motor coil, and is attenuated in a predetermined time even during a period of time in which the current of the motor current detecting section 5 does not flow. The amount of the attenuation is uniquely determined by the inductance and resistance components of the motor coil, and therefore, if the oscillation frequency is low, a time required for the attenuation is large, so that the average value of the motor coil current is low.

Thus, since the oscillation frequency of the second oscillation section 81 is set to be lower than during forward rotation (the first oscillation section 80), the average value of the motor coil current value can be lowered in a small torque region. Also, since the average value of the motor coil current is lowered, noise and vibration are reduced during braking.

Thus, by switching the oscillation frequencies of signals output from the oscillation section between during forward rotation and during braking, noise and vibration of the brushless motor 100 can be reduced both during forward rotation and during braking. Note that the first oscillation section 80 and the second oscillation section 81 may be configured to divide an oscillation frequency output from a single oscillation section to output different frequencies.

Note that, in the motor driving apparatus of this embodiment, a means for detecting a back electromotive power occurring in the brushless motor 100 may be provided instead of the rotor position sensor 1, and may be used to control the current-passage control section 3.

### Variation of First Embodiment

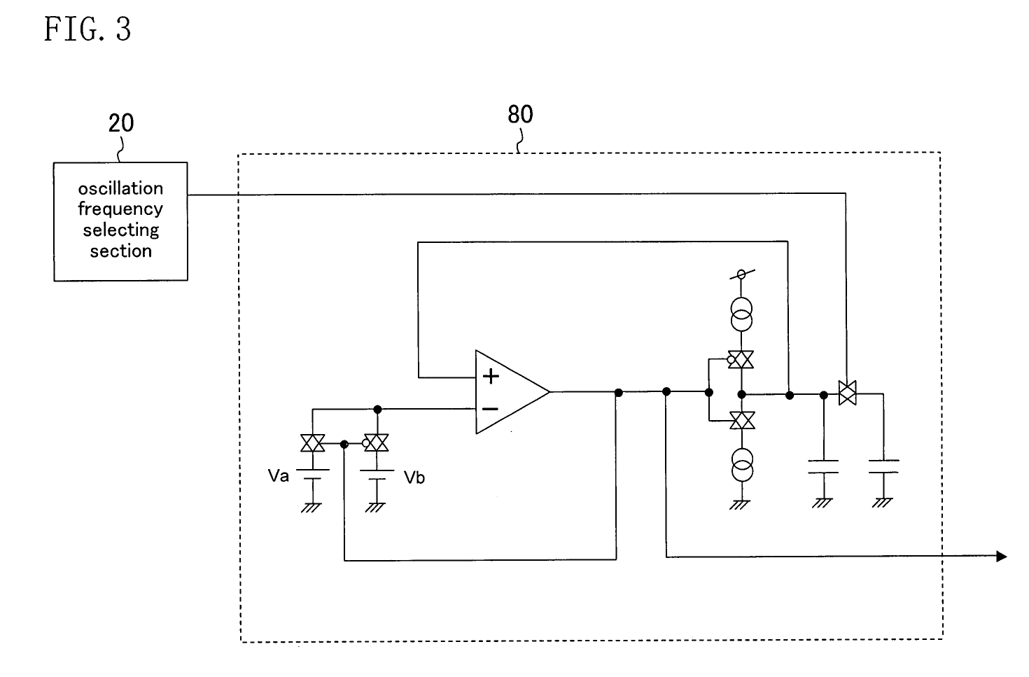

FIG. 3 is a block circuit diagram illustrating a configuration of a first oscillation section 80 in a variation of the motor driving apparatus of the first embodiment.

As illustrated in FIG. 3, in the motor driving apparatus of the first embodiment, the first oscillation section 80 can be configured to output signals having different frequencies instead of the second oscillation section 81. In this case, the first oscillation section 80 outputs a signal having a first frequency, depending on the signal of the oscillation frequency selecting section 20, during forward rotation of the motor driving apparatus, and outputs a signal having a second frequency lower than the first frequency during braking.

### Second Embodiment

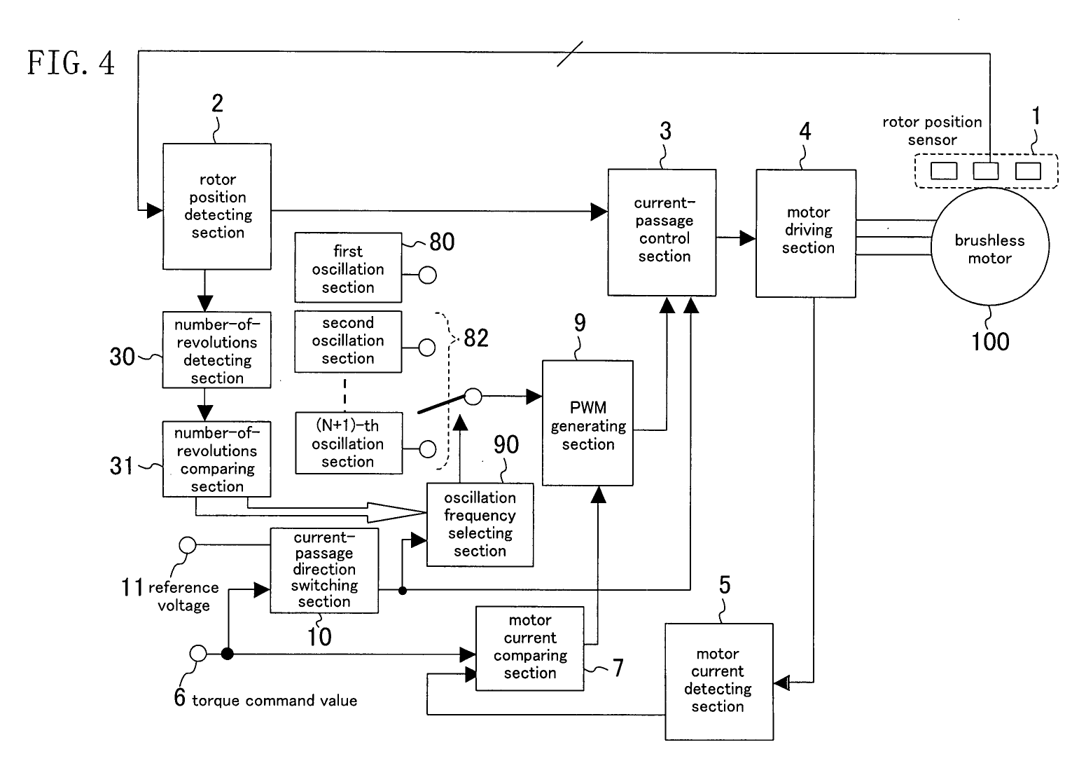

FIG. 4 is a block diagram schematically illustrating a configuration of a motor driving apparatus according to a second embodiment of the present invention. The motor driving apparatus of this embodiment has basically the same as that of the motor driving apparatus of the first embodiment, except for a number-of-revolutions detecting section 30, a number-of-revolutions comparing section 31, and an oscillation frequency selecting section 90.

Here, an oscillation section group 82 comprises second to (N+1)-th oscillation sections. The operation during forward rotation is the same as that of the motor driving apparatus of the first embodiment. Specifically, when the current-passage direction switching section 10 which compares the torque command value 6 with the reference voltage 11 outputs a forward rotation signal, the oscillation frequency selecting section 90 selects the first oscillation section 80.

Next, an operation during braking of the brushless motor 100 will be described. An output signal of the current-passage direction switching section 10 which compares the torque command value 6 with the reference voltage 11 is input as a brake signal to the oscillation frequency selecting section 90. Also, an output signal of the rotor position detecting section 2 is input to the number-of-revolutions detecting section 30. The number-of-revolutions detecting section 30 detects the current number of revolutions of the brushless motor 100 based on the output signal of the rotor position detecting section 2, and determines within which of 2 to (N+1) divided ranges of the number of revolutions the number of revolutions of the brushless motor 100 is present. The number-of-revolutions detecting section 30 can simply comprise a counter.

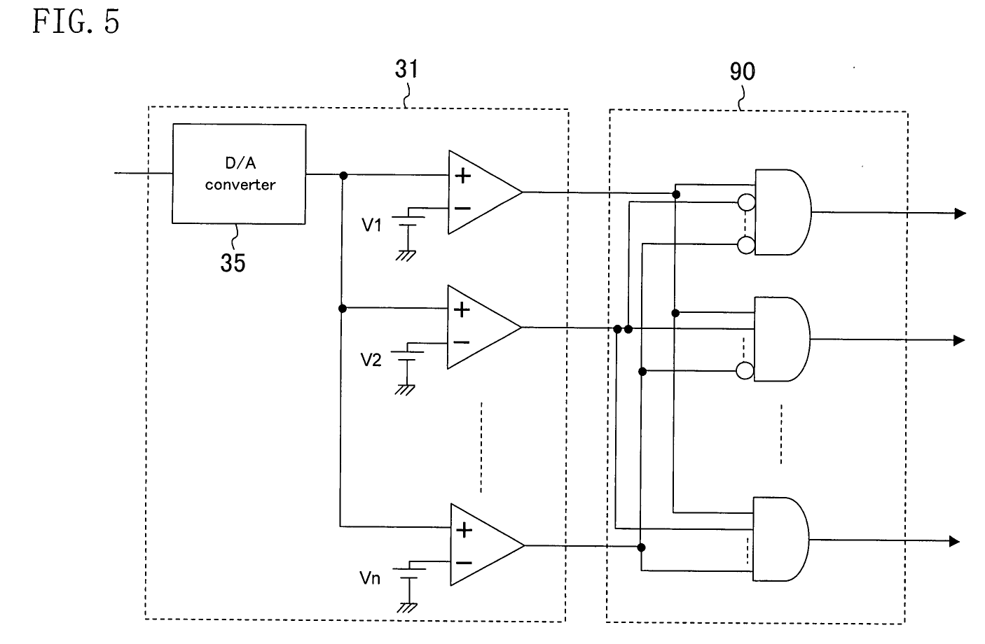

The number-of-revolutions comparing section 31 receives an output signal from the number-of-revolutions detecting section 30, and depending on the output signal, outputs a signal to the oscillation frequency selecting section 90. FIG. 5 is a block circuit diagram illustrating specific exemplary configurations of the number-of-revolutions comparing section 31 and the oscillation frequency selecting section 90. As illustrated in FIG. 5, the number-of-revolutions comparing section 31 has a D/A converter 35, and a plurality of comparators having different comparison levels. When the output signal of the number-of-revolutions detecting section 30 is input to the number-of-revolutions comparing section 31, the D/A converter 35 subjects the signal to frequency/voltage conversion to obtain a direct-current voltage, which is in turn input to each of the comparators. As the D/A converter 35, for example, an F/V converter which converts a pulse frequency signal into a voltage is preferably used. In the motor driving apparatus of this embodiment, the oscillation frequency selecting section 90 selects different oscillation sections, depending on which comparator outputs the L level or the H level. Specifically, a signal depending on the number of motor revolutions is input to the oscillation frequency selecting section 90, and depending on the number of motor revolutions, any one of the second to (N+1)-th oscillation sections of the previously set oscillation section group 82 is selected. Here, oscillation frequencies of the oscillation section group 82 are set in a stepwise manner so that a low frequency is provided when the number of motor revolutions is high, and a high frequency is provided when the number of motor revolutions is low. Note that the oscillation frequency selecting section 90 comprises a plurality of AND circuits.

Thereby, when the number of motor revolutions is high, the oscillation frequency is low, so that the average motor coil current is decreased, thereby making it possible to reduce noise and vibration during braking. Also, when the number of motor revolutions is low, the current ripple of the motor coil current can be reduced by increasing the oscillation frequency, so that noise and vibration can be reduced even in a region in which the number of revolutions is low. In particular, the oscillation frequency from the oscillation section is switched a plurality of times during braking, noise and vibration can be reduced more effectively than in the motor driving apparatus of the first embodiment.

Although any one oscillation section is selected from the oscillation section group 82 in the motor driving apparatus of this embodiment, a single oscillation section may be used to provide a variable frequency depending on the number of motor revolutions.

Note that the output signals of the (N+1) oscillation sections can be generated by, for example, dividing the oscillation frequency of a single oscillation section.

The first oscillation section 80 selected during forward rotation may be configured to output a signal having a frequency proportional to a torque command value.

### Third Embodiment

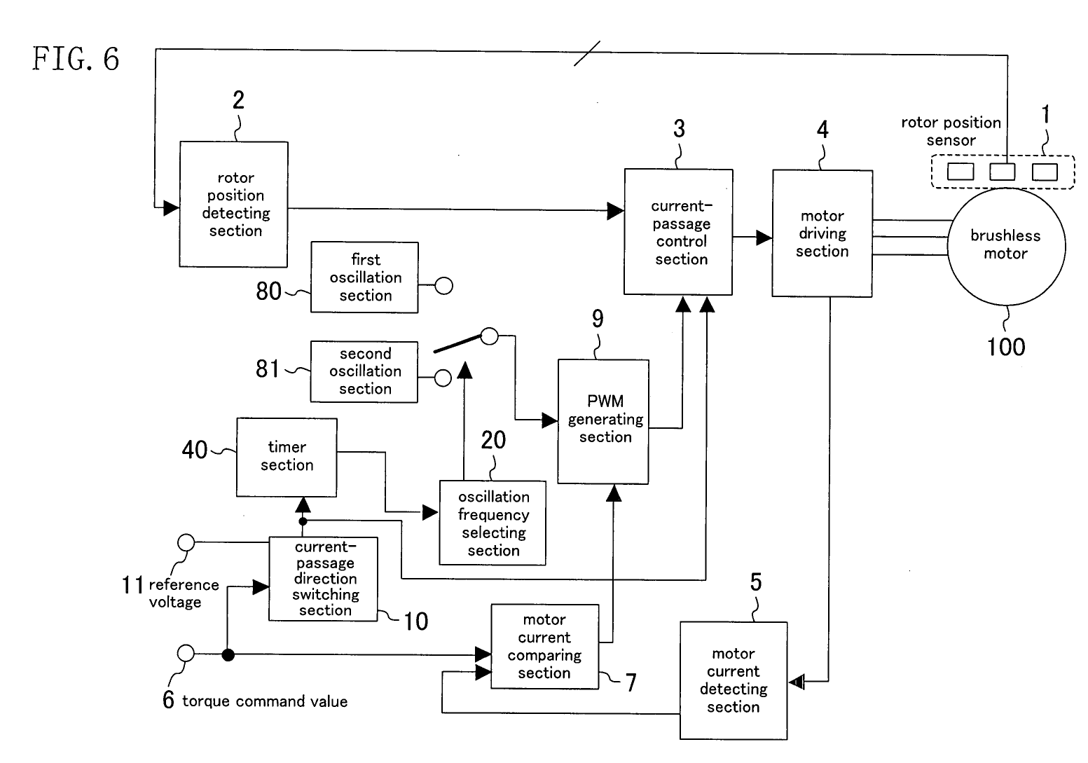

FIG. 6 is a block diagram schematically illustrating a motor driving apparatus according to a third embodiment of the present invention. The motor driving apparatus of this embodiment has a configuration similar to that of the motor driving apparatus of the first embodiment, except that a timer section 40 is provided.

The timer section 40 measures the lapse of a predetermined time after the current passage direction switching section 10 which compares the torque command value 6 with the reference voltage 11 outputs a brake signal. Only during the period of time, the oscillation frequency selecting section 20 operates to select the second oscillation section 81. As a result, the output signal of the second oscillation section 81 is input to the PWM generating section 9 during a predetermined time immediately after braking, and after the predetermined time has elapsed, the output signal of the first oscillation section 80 is input to the PWM generating section 9.

Thereby, during the predetermined period of time immediately after braking, the oscillation frequency from an oscillation section is low, so that the motor coil current has a low average current value, thereby making it possible to reduce noise and vibration during braking. Also, after the predetermined time has elapsed, the same oscillation frequency as that during forward rotation is provided, so that the current ripple of the motor coil current can be reduced, thereby making it possible to reduce noise and vibration.

The motor driving apparatus and method of the present invention can reduce noise and vibration during reverse braking of a multiphase DC brushless motor, and can be used in, for example, an apparatus for reading DVDs, CDs, or the like.

What is claimed is:

1. A motor driving apparatus comprising:
a brushless motor;
a rotor position detecting section for detecting a rotor position of the brushless motor;
a motor current detecting section for detecting a value of a current flowing through the brushless motor;
a motor current comparing section for comparing a torque command value with the current value detected by the motor current detecting section;
a current-passage direction switching section for comparing the torque command value with a reference voltage, and depending on a result of the comparison, outputting a forward rotation signal or a brake signal having a phase reverse to that of the forward rotation signal;
an oscillation section for outputting a first signal and a second signal having a frequency different from that of the first signal;
an oscillation frequency selecting section for selecting the first signal or the second signal, depending on the forward rotation signal or the brake signal of the current-passage direction switching section;
a PWM generating section for receiving the first signal or the second signal selected by the oscillation frequency selecting section, and a signal of the motor current comparing section, and generating a PWM drive signal;
a current-passage control section for combining a signal of the rotor position detecting section and the PWM drive signal; and
a motor driving section for PWM-driving the brushless motor, depending on a signal of the current-passage control section.

2. The motor driving apparatus of claim 1, wherein the oscillation section has a first oscillation section for outputting the first signal and a second oscillation section for outputting the second signal.

3. The motor driving apparatus of claim 2, wherein the first oscillation section and the second oscillation section divide an oscillation frequency of a single oscillation section and output the first signal and the second signal, respectively.

4. The motor driving apparatus of claim 2, wherein the first oscillation section can change an oscillation frequency, and
the oscillation frequency selecting section causes the first oscillation section to output a variable oscillation frequency proportional to the torque command value during forward rotation, and selects the second oscillation section during braking.

5. The motor driving apparatus of claim 1, wherein the oscillation section switches and outputs the first signal or the second signal having frequencies different from each other, depending on a signal of the oscillation frequency selecting section.

6. The motor driving apparatus of claim 1, wherein the second signal has a frequency lower than that of the first signal, and
the oscillation frequency selecting section selects the first signal when receiving the forward rotation signal, and the second signal when receiving the brake signal.

7. The motor driving apparatus of claim 6, further comprising:
a timer section for receiving the forward rotation signal and the brake signal output by the current-passage direction switching section, and when the forward rotation signal is received, outputting a signal for selecting the first oscillation section to the oscillation frequency selecting section, and when the brake signal is received, outputting a signal for selecting the second oscillation section to the oscillation frequency selecting section for a predetermined period of time.

8. The motor driving apparatus of claim 1, wherein the first signal and the second signal each have a predetermined pulse width, and during the pulse width interval, the comparison result of the motor current comparing section is ignored.

9. A motor driving apparatus comprising:
a brushless motor;
a rotor position detecting section for detecting a rotor position of the brushless motor;
a motor current detecting section for detecting a value of a current flowing through the brushless motor;
a motor current comparing section for comparing a torque command value with the current value detected by the motor current detecting section;
a current-passage direction switching section for comparing the torque command value with a reference voltage, and depending on a result of the comparison, outputting a forward rotation signal or a brake signal having a phase reverse to that of the forward rotation signal;
(N+1) oscillation sections (N≧1) for outputting signals having different frequencies;
a number-of-revolutions detecting section for detecting the number of revolutions of the brushless motor based on a signal of the rotor position detecting section;
a number-of-revolutions comparing section for comparing the number of revolutions detected by the number-of-revolutions detecting section with N predetermined divided ranges of the number of revolutions, and outputting signals having N levels;
an oscillation frequency selecting section for receiving the forward rotation signal or the brake signal of the current-passage direction switching section and a signal of the number-of-revolutions comparing section, and selecting any one of the (N+1) oscillation sections;
a PWM generating section for receiving an output signal of an oscillation section selected by the oscillation frequency selecting section, and generating a PWM drive signal;
a current-passage control section for combining a signal of the rotor position detecting section and the PWM drive signal; and
a motor driving section for PWM-driving the brushless motor, depending on a signal of the current-passage control section.

10. The motor driving apparatus of claim 9, wherein signals of the (N+1) oscillation sections are obtained by dividing an oscillation frequency of a single oscillation section.

11. The motor driving apparatus of claim 9, wherein the (N+1) oscillation sections comprise a variable signal oscillation section for outputting a signal having a frequency proportional to the torque command value, and N oscillation sections, and the current-passage direction switching section selects the variable signal oscillation section during forward rotation, and any one of the N oscillation sections during braking.

12. A method for driving a motor driving apparatus comprising a brushless motor, a rotor position detecting section for detecting a rotor position of the brushless motor, a motor current detecting section for detecting a value of a current flowing through the brushless motor, a motor current comparing section for comparing a torque command value with the current value detected by the motor current detecting section, a current-passage direction switching section for comparing the torque command value with a reference voltage, and depending on a result of the comparison, outputting a forward rotation signal or a brake signal having a phase reverse to that of the forward rotation signal, an oscillation section for outputting a first signal and a second signal having a frequency different from that of the first signal, an oscillation frequency selecting section, a PWM generating section for receiving a signal of the motor current comparing section, and generating a PWM drive signal, a current-passage control section for combining a signal of the rotor position detecting section and the PWM drive signal, and a motor driving section for PWM-driving the brushless motor, depending on a signal of the current-passage control section, the method comprising:
causing the oscillation frequency selecting section to select and output the first signal or the second signal, depending on the forward rotation signal or the brake signal of the current-passage direction switching section, to the PWM generating section.

13. The method of claim 12, wherein the oscillation section has a first oscillation section for outputting the first signal and a second oscillation section for outputting the second signal.

14. The method of claim 13, wherein the first signal and the second signal are generated by dividing an oscillation frequency of a single signal.

15. The method of claim 13, wherein the first signal output by the first oscillation section has an oscillation frequency proportional to the torque command value, and the oscillation frequency selecting section selects the first signal when receiving the forward rotation signal, and the second signal when receiving the brake signal.

16. The method of claim 12, wherein the second signal has a frequency lower than that of the first signal, and
the oscillation frequency selecting section selects the first signal when receiving the forward rotation signal, and the second signal when receiving the brake signal.

17. The method of claim 13, wherein the motor driving apparatus further comprises a timer section, and
the timer section, when receiving the forward rotation signal, outputs a signal for selecting the first oscillation section to the oscillation frequency selecting section, and when receiving the brake signal, outputs a signal for selecting the second oscillation section to the oscillation frequency selecting section for a predetermined period of time.

18. A method for driving a motor driving apparatus comprising a brushless motor, a rotor position detecting section for detecting a rotor position of the brushless motor, a motor current detecting section for detecting a value of a current flowing through the brushless motor, a motor current comparing section for comparing a torque command value with the current value detected by the motor current detecting section, a current-passage direction switching section for comparing the torque command value with a reference voltage, and depending on a result of the comparison, outputting a forward rotation signal or a brake signal having a phase reverse to that of the forward rotation signal, an oscillation section for outputting (N+1) signals having frequencies different from each other, a number-of-revolutions detecting section for detecting the number of revolutions of the brushless motor based on a signal of the rotor position detecting section, a number-of-revolutions comparing section for comparing the number of revolutions detected by the number-of-revolutions detecting section with N predetermined divided ranges of the number of revolutions, and outputting signals having N levels (N≧1), an oscillation frequency selecting section, a PWM generating section for receiving a signal of the motor current comparing section, and generating a PWM drive signal, a current-passage control section for combining a signal of the rotor position detecting section and the PWM drive signal, and a motor driving section for PWM-driving the brushless motor, depending on a signal of the current-passage control section, the method comprising:
causing the oscillation frequency selecting section to select any one of the (N+1) oscillation sections, depending on a level of the signal of the number-of-revolutions comparing section.
